(19) United States
(12) Patent Application Publication
(10) Pub. No.: US 2008/0169309 A1
(43) Pub. Date: Jul. 17, 2008

(54) Dispenser For Dispensing Viscous Food Products

(75) Inventor: Daniel R. Kroeger, Cincinnati, OH (US)

Correspondence Address: WOOD, HERRON & EVANS, LLP, 2700 CAREW TOWER, 441 VINE STREET, CINCINNATI, OH, 45202, US

(73) Assignee: GOLD MEDAL PRODUCTS COMPANY, Cincinnati, OH (US)

(21) Appl. No.: 11/622,804

(22) Filed: Jan. 12, 2007

(51) Int. Cl. B67D 5/62; B65D 37/00

(52) U.S. Cl. 222/146.5; 222/214

(57) ABSTRACT

A dispenser for dispensing food products at an elevated temperature includes a housing for supporting and heating a container of food product located within the housing and a pump for moving the food product from the container to a location external to the housing. One or more actuators are operatively connected to the pump and are selectively configurable to operate the pump in a first momentary state for dispensing the food product while the actuator is actuated and a second timed state for dispensing the food product for a predetermined period of time. An interlock device is provided to disable the pump when the housing is opened.

### FIELD OF THE INVENTION

The present invention relates generally to fluid dispensers and, more particularly, to a dispenser for dispensing viscous food products at an elevated temperature.

### BACKGROUND OF THE INVENTION

Dispensers for dispensing various food products at an elevated temperature are known. These dispensers are typically found at restaurants, convenience stores and concession stands for dispensing cheese sauces, ice cream toppings, syrups, chili or other food products. Typically, these types of food products do not flow well at room temperature so the dispenser is designed to heat and maintain the food product at an elevated temperature, thereby increasing the flow capability of the food product. The food product may be pre-packaged in a flexible bag or pouch having an elongated flexible hose through which the food product is dispensed from a discharge end of the hose. The pouch is heated within the dispenser by heated air circulated within the dispenser and a pump is provided in the dispenser to move the food product from the pouch to the discharge end of the hose located external to the dispenser.

Dispensers of this type are typically configured with a single button located on a housing of the dispenser to operate the pump only while the button is depressed and maintained depressed by the user. Alternatively, the dispenser may be configured to operate the pump for a predetermined period of time when the single button is initially depressed by the user.

One of the drawbacks of such a dispenser is that the dispenser is configured for only one type of dispensing operation, i.e., the dispenser is configured to only operate when the user depresses and maintains depression of the single button or, alternatively, the dispenser is configured to only dispense food product for a predetermined period of time when the button is initially depressed. The dispenser can only be configured to operate in one of these two modes of operation at a given time. If a change in the mode of operation of the dispenser is desired, the user must reconfigure the dispenser for the desired mode of operation which is thereafter fixed until the dispenser is yet again reconfigured.

While this type of the dispenser may be well suited for a particular dispensing environment in which only one or the other mode of operation is desired, it is typically not convenient for dispensing environments that require different volumes of food product to be dispensed from the dispenser at different times.

For example, the timed operation of the pump may be well suited to dispense cheese onto a hot dog, but the single button may need to be depressed multiple times by the user to fill a cheese cup for nachos, for example. This requires extra time and attention by the user which may be at a premium during busy times. If the dispenser is configured to dispense food product only when the button is depressed and maintained depressed by the user, the user is required to remain at the dispenser until the desired volume of food product is dispensed. This does not allow the user to perform other tasks that may be required at the same time.

Accordingly, there is a need for a dispenser for dispensing viscous food products at an elevated temperature that is readily suitable for various dispensing requirements.

There is also a need for such a dispenser that minimizes the attention required by the user to dispense food product in desired volume from the dispenser.

### SUMMARY OF THE INVENTION

The present invention overcomes the foregoing and other shortcomings and drawbacks of dispensers for dispensing viscous food products heretofore known. While the invention will be described in connection with certain embodiments, it will be understood that the invention is not limited to these embodiments. On the contrary, the invention includes all alternatives, modifications and equivalents as may be included within the spirit and scope of the present invention.

In accordance with principles of the present invention, a dispenser is provided for dispensing viscous food product at an elevated temperature from the dispenser. In one embodiment, the dispenser includes a substantially enclosed housing that defines a heated internal cavity for heating and supporting a container of viscous food product located within the housing. The container may comprise a flexible bag or pouch that has an elongated flexible hose through which the food product is dispensed from a discharge end of the hose. A fan and heater are provided in the dispenser to circulate heated air within the internal cavity to heat the food product within the container.

The dispenser includes a pump that is configured to move the food product from the container to a location external to the enclosed housing. In one embodiment, the pump is a peristaltic pump having a rotor with pinch rollers that contact and pinch the flexible hose to move the food product toward the discharge end of the tube. When the pump is stopped, the pinch rollers sufficiently block the flow of food product through the flexible hose so that food product is not dispensed from the dispenser.

In accordance with one aspect of the present invention, the dispenser includes a plurality of actuators operatively coupled to the pump. One of the actuators is configured to operate the pump in a momentary state for dispensing the food product while the actuator is maintained actuated by the user and another of the actuators is configured to operate the pump in a timed state for dispensing the food product for a predetermined period of time. In this way, the dispenser is configured to readily operate in either mode of operation depending on which actuator is actuated by the user.

In accordance with another aspect of the present invention, the dispenser includes a plurality of actuators operatively coupled to the pump. One of the actuators is configured to operate the pump in a timed state for a first predetermined period of time and another of the actuators is configured to operate the pump in the timed state for a second predetermined period of time. In this way, the dispenser may be programmed to dispense different volumes of food product for different dispensing requirements with minimal attention by the user.

In accordance with yet another aspect of the present invention, the dispenser includes an interlock device to stop the operation of pump when a front door of the dispenser is opened. In one embodiment, the interlock device comprises a magnetically operated switch mounted on the housing and a cooperating magnet located on the door. When the door is opened, the magnetically operated switch is actuated to stop and prevent operation of pump. When the door is closed, the magnetically operated switch is actuated to permit operation of the pump.

These and other objects and advantages of the present invention will be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a perspective view of a dispenser for dispensing viscous food product at an elevated temperature in accordance with one embodiment of the present invention;

FIG. 2 is a front elevational view of the dispenser shown in FIG. 1, showing dispenser opened;

FIG. 3 is a side elevational view of the dispenser shown in FIG. 1; and

FIG. 4 is a schematic view of a control system for operating the dispenser of FIG. 1.

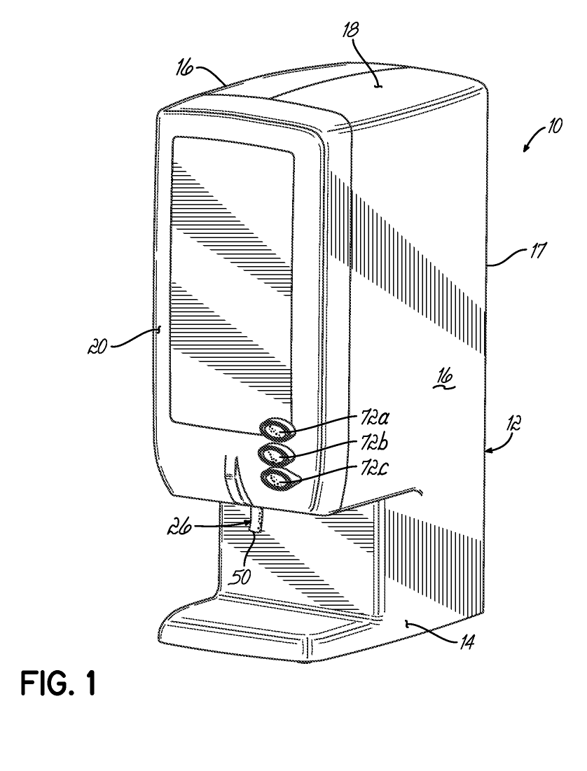

### DETAILED DESCRIPTION OF THE PREFERRED EMBODIMENTS

Referring now to the Figures, a dispenser 10 for dispensing viscous food products at an elevated temperature is shown in accordance with one embodiment of the present invention. Dispenser 10 includes a substantially enclosed housing 12 having a base 14, a pair of vertical side walls 16, rear wall 17, a top wall 18, and a hinged front door 20. The housing 12 may be made of a washable, food-grade plastic or other suitable material. As will be described in greater detail below, the housing 12 defines a heated internal cavity 22 for heating a container 24 of food product located within the housing 12.

In one embodiment, the container 24 of food product may comprise a flexible pouch or bag known to those skilled in the art for containing the food product therein and an elongated flexible hose or discharge tube 26 in fluid communication with the pouch 24. By way of example, the food product may comprise a cheese sauce, ice cream topping, syrup, chili or other viscous food product that generally congeals or is otherwise resistant to flow until it is heated above room temperature.

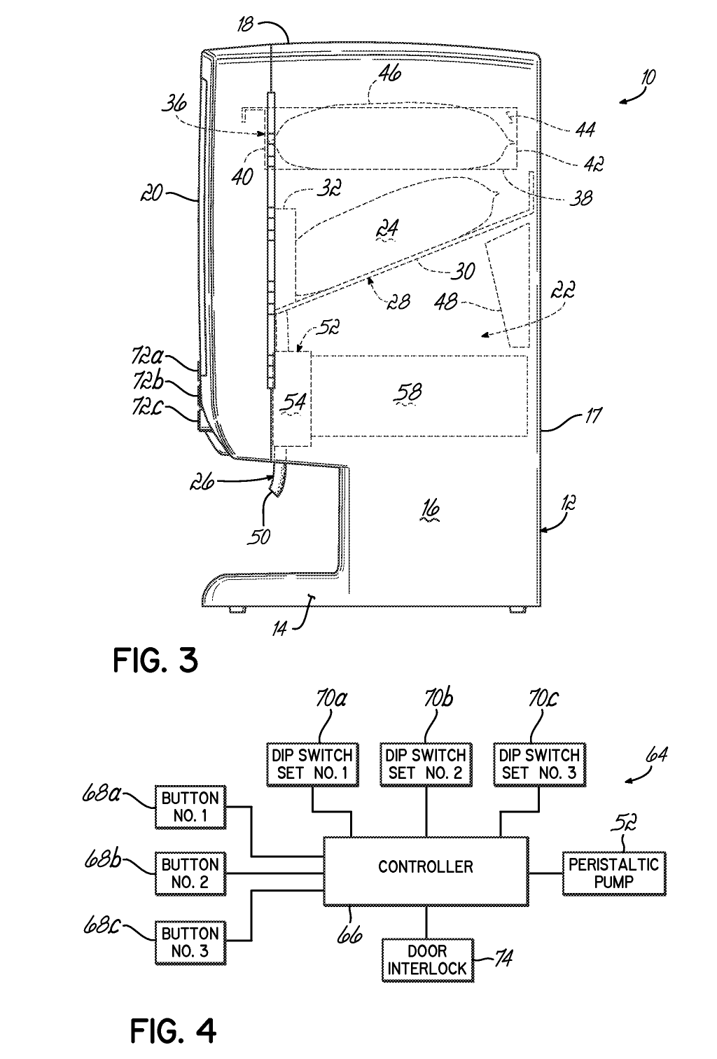

A receptacle 28, such as an inclined shelf by way of example as shown in FIG. 3, is provided within the internal cavity 22 and is configured to support the pouch 24 with a front end of the pouch 24 inclined downwardly relative to the rear end of the pouch 24. In this way, the food product within the pouch 24 is urged by gravity through an opening in the front end of the pouch 24 and toward the flexible hose 26 when the food product is heated to an elevated temperature.

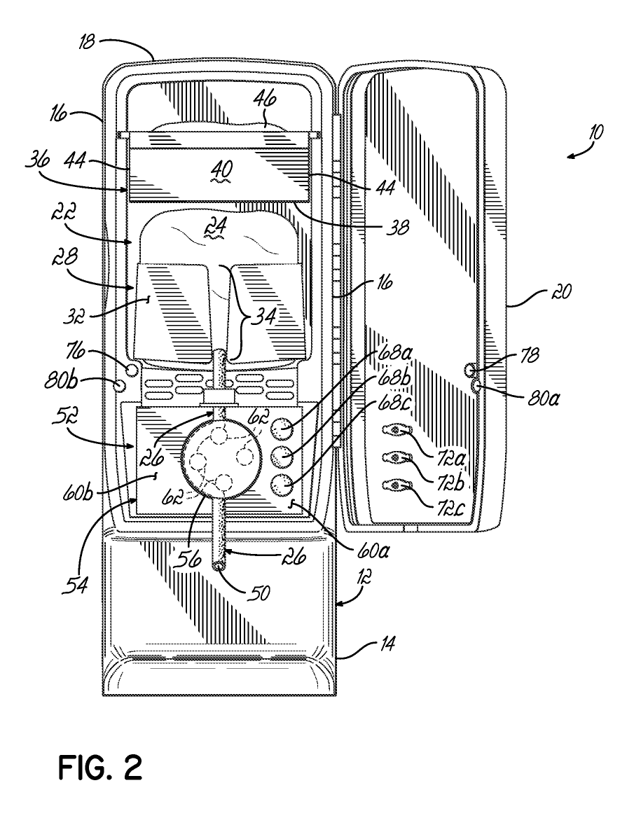

In one embodiment, the receptacle 28 includes an inclined bottom wall 30, a generally vertical front wall 32, and an elongated slot 34 formed in the front wall 32. When the flexible pouch 24 is supported on or in the receptacle 28, the flexible hose 26 passes through the slot 34 and extends downwardly from the front end of the pouch 24 as shown in FIG. 2. While the container 24 is described and illustrated herein as comprising a flexible bag or pouch in one embodiment, it will be understood by those of ordinary skill in the art that the container 24 may take many other forms without departing from the spirit and scope of the present invention. For example, the container 24 may comprise a generally rigid reservoir or other container structure into which the viscous food product is poured or, alternatively, into which the food product is pre-packaged and placed within the internal cavity 22. Moreover, the receptacle 28 may take many other forms in other embodiments, such as a tray by way of example, and so is not limited to an inclined shelf as shown and described herein. In one embodiment, the receptacle 28 may be made of metal or other suitable thermally conductive material so as to conduct heat to the pouch 24 as will be described in detail below.

As shown in FIGS. 2 and 3, the dispenser 10 may include a second receptacle 36 located above the receptacle 28. In one embodiment, the second receptacle 36 may comprise a slidable tray having a bottom wall 38, a front wall 40, a rear wall 42 and a pair of side walls 44 by way of example. The second receptacle 36 may be provided to support a second replacement container 46 of food product so that the second container 46 is also heated within the housing 12. The second receptacle 36 may also be used to support other food products within the housing 12.

In one embodiment, the dispenser 10 includes a fan 48 (FIG. 3) mounted to the rear wall 17 of the housing 12 and a heater (not shown) associated with the fan 48. The fan 48 is located beneath the receptacle 28 and circulates heated air within the internal cavity 22 to heat the containers 24 and 46 and a substantial length of the flexible hose 26. In this way, the food product may be maintained at an elevated temperature within the pouches 24 and 46 and generally to near the distal or discharge end 50 of the hose 26.

As shown in FIGS. 2 and 3, the dispenser 10 includes a pump 52 for moving the food product from the pouch 24 to the discharge end 50 of the flexible hose 26. In one embodiment, the pump 52 is a peristaltic pump having a pump housing 54, a rotor 56 (FIG. 2) and a motor 58 (FIG. 3) for rotating the rotor 56. The pump housing 54 includes two components 60a and 60b that form a stator. The first pump component 60a is stationary while the second pump component 60b is mounted to slide toward and away from the rotor 56.

In one embodiment, the flexible hose 26 is positioned between the slidable second pump component 60b and the rotor 56 as shown in FIG. 2, with the discharge end 50 of the hose 26 extending downwardly from the pump 52 and external to the housing 12. The rotor 56 includes a plurality of pinch rollers 62 (FIG. 2) that are spaced circumferentially around the rotor 56. As the rotor 56 is rotated by the motor 58, the pinch rollers 62 contact and pinch the flexible hose 26 to move the food product toward the discharge end 50 of the hose 26. When the pump 52 is stopped, the pinch rollers 62 sufficiently block the flow of food product through the flexible hose 26 so that food product is not dispensed from the dispenser 10. The flexible hose 26 may be removed from the pump 52 by moving the second pump component 60b away from the rotor 56. When the container 24 is replaced, the flexible hose 26 of the new or replacement container 24 is inserted between the second pump component 60b and the rotor 56 and the second pump component 60b is then moved toward the rotor 56 so that the pinch rollers 62 contact the flexible hose 26. One peristaltic pump configuration suitable for use in the device 10 is described in U.S. Pat. Nos. 5,803,317 and 6,003,733, each disclosure of which is incorporated herein by reference in its entirety. While a peristaltic pump is shown and described herein, it will be appreciated that other types of pumps well known to those of ordinary skill in the art are possible as well.

In accordance with one aspect of the present invention, a control system 64 (FIG. 4) is provided to operate the pump 52 to discharge food product through the flexible hose 26. The control system 64 includes a controller 66, multiple buttons 68a-c (FIG. 2) and multiple dip switches 70a-c that define various actuation settings or operations of the pump 52 in response to actuation of the buttons 68a-c. In one embodiment, manually depressable buttons 72a-c are provided on the front door 20 of the housing 12 that engage and actuate the buttons 68a-c when the buttons 72a-c on the front door 20 are depressed.

The controller 66 may take many forms and may comprise a digital, analog or digital/analog controller as will be understood by those of ordinary skill in the art. The dip switches 70a-c is associated with each of the respective buttons 68a-c and are individually settable to define a different operation of the pump 52 when any one of the buttons 72a-c is depressed. While dip switches 70a-c is described herein in one embodiment, it will be appreciated that other setting devices are possible as well.

In one embodiment, one or more of the dip switches 70a, 70b and/or 70c may be set so that the pump 52 will operate in a momentary state to discharge food product from the discharge end 50 of the flexible hose 26 only while the button 72a, 72b and/or 72c is depressed. The pump 52 will be actuated only while the user maintains depression of the button 72a, 72b and/or 72c so that a variable volume of food product may be dispensed depending on how long the button 72a, 72b and/or 72c is depressed. When the button 72a, 72b and or 72c are released, the pump 52 will stop operating to stop dispensing of food product from the dispenser 10.

One or more of the dip switches 70a-c may also be set so that the pump 52 will operate in a timed state to discharge food product from the discharge end 50 of the flexible hose 26 for a predetermined period of time following depression of the button 72a, 72b and/or 72c. Each of the dip switches 70a-c may be individually set so that the predetermined period of time varies for each of the buttons 72a, 72b and/or 72c. The controller 66 may include a timer that controls the predetermined period of time set for one or more of the buttons 72a-c. The pump 52 will be actuated for the predetermined period of time upon depression and release of the button 72a, 72b and/or 72c so that different volumes of food product may be dispensed from the dispenser 12 depending on which button 72a, 72b and/or 72c is depressed.

In one embodiment, one of the dip switches 70a, 70b or 70c may be set to operate the pump 52 in a momentary state, while the other dip switches 70a, 70b and/or 70c may be set to operate the pump 52 in the timed state, with each timed state being different for each button 72a, 72b and/or 72c. For example, one of the buttons 72a, 72b and/or 72c may be set to operate the pump 52 in a momentary state to fill a cheese cup with a predetermined volume of cheese, the second button 72a, 72b and/or 72c may be set to operate the pump 52 for a relatively short period of time for dispensing a proper volume of cheese onto a hot dog and the third button 72a, 72b and/or 72c may be set to a operate the pump for a longer period of time for dispensing a proper volume of cheese onto nacho chips. In this way, the user is able to configure the dispenser 10 at one time to provide various operations of the pump 52 to optimize use of the dispenser 10 for different dispensing requirements. Moreover, the attention required of the user is minimized for each type of dispensing operation.

In accordance with another aspect of the present invention, the dispenser 10 includes an interlock device 74 (FIGS. 2 and 4) to stop the operation of pump 52 when the front door 20 is opened. In one embodiment, the interlock device 74 comprises a magnetically operated switch 76 (FIG. 2) mounted on the housing 12 and a cooperating magnet 78 (FIG. 2) located on the front door 20. When the door 20 is opened, the magnetically operated switch 76 is actuated to stop and prevent operation of pump 52. When the door 20 is closed, the magnetically operated switch 76 is actuated to permit operation of the pump 52. While a magnetically operated switch 76 is described herein in one embodiment, it will be appreciated that other types of interlock devices are possible as well. A second pair of magnets 80a, 80b (FIG. 2) are provided on the door 20 and housing 12, respectively, to facilitate closing of the door 20.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicants' general inventive concept.

What is claimed is:

1. A dispenser for dispensing viscous food products, comprising:
a substantially enclosed housing defining an internal cavity configured to support a container of viscous food product therein, the enclosed housing having an entry into the internal cavity;
a heater configured to heat the food product within the container;
a pump configured to move the food product from the container to a location external to the substantially enclosed housing; and
a plurality of actuators operatively coupled to the pump, wherein one of the actuators is configured to operate the pump in a momentary state for dispensing the food product while the actuator is maintained actuated and another of the actuators is configured to operate the pump in a timed state for dispensing the food product for a predetermined period of time.

2. The dispenser of claim 1, wherein the plurality of actuators include a programmable control device operatively coupled to the pump.

3. The dispenser of claim 1, further comprising a first receptacle configured to support the container of food product.

4. The dispenser of claim 3, wherein the first receptacle comprises an inclined shelf.

5. The dispenser of claim 3, further comprising a second receptacle disposed above the first receptacle.

6. The dispenser of claim 5, wherein the second receptacle comprises a slidable tray.

7. A dispenser for dispensing viscous food products, comprising:
a substantially enclosed housing defining an internal cavity configured to support a container of viscous food product therein, the enclosed housing having an entry into the internal cavity;
a heater configured to heat the food product within the container;
a pump configured to move the food product from the container to a location external to the substantially enclosed housing; and
a plurality of actuators operatively coupled to the pump, wherein one of the actuators is configured to operate the pump in a timed state for a first predetermined period of time and another of the actuators is configured to operate the pump in the timed state for a second predetermined period of time.

8. The dispenser of claim 7, wherein the plurality of actuators include a programmable control device operatively coupled to the pump.

9. A dispenser for dispensing viscous food products, comprising:
a substantially enclosed housing defining an internal cavity configured to support a container of viscous food product therein, the enclosed housing having an entry into the internal cavity;
a heater configured to heat the food product within the container;
a pump configured to move the food product from the container to a location external to the substantially enclosed housing; and
a plurality of actuators operatively coupled to the pump, wherein each of the actuators is configured to operate the pump in a different manner.

10. A dispenser for dispensing viscous food products, comprising:
a substantially enclosed housing defining an internal cavity configured to support a container of viscous food product therein, the enclosed housing having an entry into the internal cavity;
a heater configured to heat the food product within the container;
a pump configured to move the food product from the container to a location external to the substantially enclosed housing; and
an interlock device operatively coupled to the pump and being configured to disable the pump when the entry into the internal cavity is opened.

11. The dispenser of claim 10, wherein the interlock device is a magnetically operated switch supported by the substantially enclosed housing.

12. The dispenser of claim 11, further comprising a magnet associated with the entry into the internal cavity and being configured to operate the magnetically operated switch.

13. The dispenser of claim 12, wherein the entry into the internal cavity comprises a door.
